(19) United States
(12) Patent Application Publication
(10) Pub. No.: US 2019/0264862 A1
(43) Pub. Date: Aug. 29, 2019

(54) PIVOTING LEG ASSEMBLIES FOR SELF-LEVELING DEVICES

(71) Applicant: Gary C. HOYLE, Cumming, GA (US)

(72) Inventor: Gary C. HOYLE, Cumming, GA (US)

(21) Appl. No.: 15/906,384

(22) Filed: Feb. 27, 2018

(51) Int. Cl. F16M 11/16; A47B 13/00; A47C 7/00

(52) U.S. Cl. CPC F16M 11/16; B25H 1/04; A47C 7/008; A47B 13/003

(57) ABSTRACT

A rotatable bracket assembly for use with self-leveling devices that includes a first bracket portion having an upper region with an outer surface and a substantially flat inner surface, wherein a cylindrical carriage bolt receiving structure is formed on one end of the inner surface; and a lower region having an outer surface and an inner surface, wherein a stem and flange receiving region is formed on the inner surface; and a second bracket portion that is adapted to be connected to the first bracket portion, wherein the second bracket portion further includes an upper region having an outer surface and a substantially flat inner surface, wherein a cylindrical carriage bolt receiving structure is formed on one end of the inner surface; and a lower region having an outer surface and an inner surface, wherein a stem and flange receiving region is formed on the inner surface.

### BACKGROUND OF THE INVENTION

The described invention relates in general to self-leveling or self-adjusting supports of various types, and more specifically to supportive leg assemblies for use with such devices that may be folded or collapsed inward for ease of transportation and storage.

Substantially flat or planar platforms are common utilitarian components found in many items including tables; benches; chairs; cooking surfaces; work surfaces; elevated storage containers; hunting, fishing, and camping products; and many others. Most of these platforms are most useful when they are in a level position (i.e., positioned horizontally). However, placing and holding a substantially flat or planar platform in a level position can be challenging, particularly when the surface or substrate upon which the platform is placed is uneven. In restaurants, coffee shops, and other establishments, encountering tables or chairs that wobble or tilt, or that are otherwise unstable is a common and annoying occurrence for many people. An unstable table or chair is also more likely to collapse or fall over, thereby creating a risk of injury to the person using the item. Furthermore, an unstable work platform may present a significant safety hazard, particularly if the platform is being used for activity that involves sawing or other reciprocating motion that would encourage the work platform to tip over or collapse. Legs or other support structures attached to such platforms may be collapsible, foldable, or adjustable with regard to height and/or angle relative to the platform itself; however, these support structures are not typically adjustable with regard to maintaining the platform in a level position when the platform is sitting on an uneven substrate.

Self-adjusting support assemblies for use on uneven substrates or surfaces are described in U.S. Pat. Nos. 9,140,401 and 9,453,608, which are incorporated herein by reference, in their entirety, for all purposes. U.S. Pat. Nos. 9,140,401 and 9,453,608 both teach a self-adjusting support assembly for use on uneven surfaces that includes: (a) a support element (e.g., a platform, work surface, tabletop, or seat); (b) at least one pivoting leg assembly positioned beneath the support element; and (c) at least one self-adjusting attachment assembly connecting the support element to the at least one pivoting leg assembly. Each self-adjusting attachment assembly includes: (i) a bracket that is adapted to attach to the support element; and (ii) a proximal head portion that is adapted to rotationally cooperate with the bracket and to receive the pivoting leg assembly. The bracket includes: (i) a receiving channel formed therein that is positioned along a predetermined angled axis of insertion; and (ii) a locking ridge positioned within the receiving channel. The proximal head portion includes: (i) a flange formed at one end thereof that rotationally engages the locking ridge; (ii) a stem positioned beneath the flange that rotationally engages the receiving channel; and (iii) a receiving portion positioned beneath the stem that is adapted to receive the pivoting leg assembly.

The self-adjusting attachment assemblies taught by U.S. Pat. Nos. 9,140,401 and 9,453,608 can be attached to and effectively used with almost any type of platform, and many types of pre-existing devices (tables, benches, chairs, etc.) can be modified by retrofitting to include the self-adjusting attachment assemblies and the pivoting leg assemblies with which the self-adjusting attachment assemblies are designed to work. However, the pivoting leg assemblies, which are typically triangular, can create certain challenges associated with transporting and storing the platforms to which the pivoting leg assemblies are attached. Accordingly, there is a need for leg assemblies for use with the self-leveling devices described in U.S. Pat. Nos. 9,140,401 and 9,453,608 that can be rotated into a position more conducive to easy transportation and storage of the self-leveling devices.

### SUMMARY OF THE INVENTION

The following provides a summary of certain exemplary embodiments of the present invention. This summary is not an extensive overview and is not intended to identify key or critical aspects or elements of the present invention or to delineate its scope. However, it is to be understood that the use of indefinite articles in the language used to describe and claim the present invention is not intended in any way to limit the described system. Rather the use of “a” or “an” should be interpreted to mean “at least one” or “one or more”.

In accordance with one aspect of the present invention, a rotatable bracket assembly for use with self-leveling devices is provided. This rotatable bracket assembly includes a first bracket portion having an upper region with an outer surface and a substantially flat inner surface, wherein a cylindrical carriage bolt receiving structure is formed on one end of the inner surface; and a lower region having an outer surface and an inner surface, wherein a stem and flange receiving region is formed on the inner surface; and a second bracket portion that is adapted to be connected to the first bracket portion, wherein the second bracket portion further includes an upper region having an outer surface and a substantially flat inner surface, wherein a cylindrical carriage bolt receiving structure is formed on one end of the inner surface; and a lower region having an outer surface and an inner surface, wherein a stem and flange receiving region is formed on the inner surface.

In accordance with another aspect of the present invention, a rotatable bracket assembly for use with self-leveling devices is provided. This rotatable bracket assembly includes a first bracket portion having an upper region with an outer surface and a substantially flat inner surface, wherein a cylindrical carriage bolt receiving structure is formed on one end of the inner surface; and a lower region having an outer surface and an inner surface, wherein a stem and flange receiving region is formed on the inner surface; and a second bracket portion, wherein the second bracket portion is adapted to be connected to the first bracket portion, and wherein the second bracket portion further includes an upper region having an outer surface and a substantially flat inner surface, wherein a cylindrical carriage bolt receiving structure is formed on one end of the inner surface; and a lower region having an outer surface and an inner surface, wherein a stem and flange receiving region is formed on the inner surface, wherein the stem and flange receiving region in the first bracket portion and the stem and flange receiving region in the second bracket portion cooperate with one another to receive and enclose a rotating and pivoting leg assembly, and wherein the rotating and pivoting leg assembly includes a pivot device, and wherein the pivot device further includes an elongated stem, and a flange formed atop the elongated stem.

In yet another aspect of this invention, a rotatable bracket assembly for use with self-leveling devices is provided. This bracket assembly includes a horizontally-oriented crossbar having at least one aperture formed therein and passing completely therethrough; a first bracket portion adapted to be rotatably mounted on the crossbar, wherein the first bracket portion further includes an upper region having an outer surface and a substantially flat inner surface, wherein a cylindrical carriage bolt receiving structure is formed on one end of the inner surface, and wherein the cylindrical carriage bolt receiving structure is adapted to be disposed within the at least one aperture formed in the crossbar; and a lower region having an outer surface and an inner surface, wherein a stem and flange receiving region is formed on the inner surface; and a second bracket portion adapted to be rotatably mounted on the crossbar, wherein the second bracket portion is adapted to be connected to the first bracket portion, and wherein the second bracket portion further includes an upper region having an outer surface and a substantially flat inner surface, wherein a cylindrical carriage bolt receiving structure is formed on one end of the inner surface, and wherein the cylindrical carriage bolt receiving structure is adapted to be disposed within the at least one aperture formed in the crossbar; and a lower region having an outer surface and an inner surface, wherein a stem and flange receiving region is formed on the inner surface, wherein the stem and flange receiving region in the first bracket portion and the stem and flange receiving region in the second bracket portion cooperate with one another to receive and enclose a rotating and pivoting leg assembly, and wherein the rotating and pivoting leg assembly includes a pivot device, and wherein the pivot device further includes an elongated stem, and a flange formed atop the elongated stem.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a perspective view of a self-leveling support device (sawhorse configuration) that includes inwardly rotating leg assemblies in accordance with an exemplary embodiment of the present invention, wherein the leg assemblies are shown in the extended position;

FIG. 2 is a perspective view of a portion of the left side of the self-leveling support device of FIG. 1 showing an exemplary embodiment of one of the inwardly rotating leg assemblies;

FIG. 3 is an exploded view of the portion of the self-leveling support device of FIG. 2 showing the positions of the upper portion of the first leg assembly, the first and second bracket portions, and the support member (crossbar) relative to one another;

FIG. 4 is an assembled view of the apparatus of FIG. 3 shown in the fully extended position relative to the support member;

FIG. 5 is an assembled view of the apparatus of FIG. 3 shown in the fully closed or folded position relative to the support member;

FIG. 6 is a cross-sectional, perspective view of apparatus of FIG. 3 showing the manner in which the first and second bracket portions engage the support member, and the manner in which the carriage bolt is inserted therethrough; and

FIG. 7 is a top perspective view of the self-leveling support device of FIG. 1 showing both leg assemblies in the fully closed position relative to the support member.

### DETAILED DESCRIPTION OF THE INVENTION

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

The present invention provides inwardly rotating support brackets for use with the self-leveling devices described in U.S. Pat. Nos. 9,140,401 and 9,453,608 and other systems and devices. The STABLZ® family of products provides various platforms that are supported by sets of uniquely shaped legs that operate to “self-level” these platforms on uneven substrates. Within the context of this invention and in describing the STABLZ® products generally, the phrase “self-leveling” refers to the mechanical relationship between the platform, the legs (which are typically triangular in overall shape) that support the platform, and the bracket assembly that attaches the legs to the platform. The bracket assembly receives and houses the legs in a manner that permits the upper portion of the legs to rotate and pivot, independent of one another, thereby permitting a user of the device to orient or adjust the platform into a level position even if the bottom portions of the legs are resting on an uneven substrate or surface. However, the pivoting leg assemblies, which are typically triangular, can create certain challenges associated with transporting and storing the platforms to which the pivoting leg assemblies are attached. Accordingly, the present invention provides leg assemblies for use with the self-leveling devices described in U.S. Pat. Nos. 9,140,401 and 9,453,608 that can be rotated into a position more conducive to easy transportation and storage of the self-leveling devices.

With reference to the Figures, exemplary self-leveling device 10 includes first leg assembly 100, second leg assembly 200, first rotating/pivoting bracket assembly 300, second rotating/pivoting bracket assembly 400, and support member 500, which in this embodiment is a crossbeam similar to a 2×4 piece of lumber or the like. The embodiment of the invention shown in the Figures functions in a manner similar to a sawhorse-type device; however, support member 500 may be used to support all or at least a portion of a horizontal platform such as a table top or work surface that must be leveled prior to use.

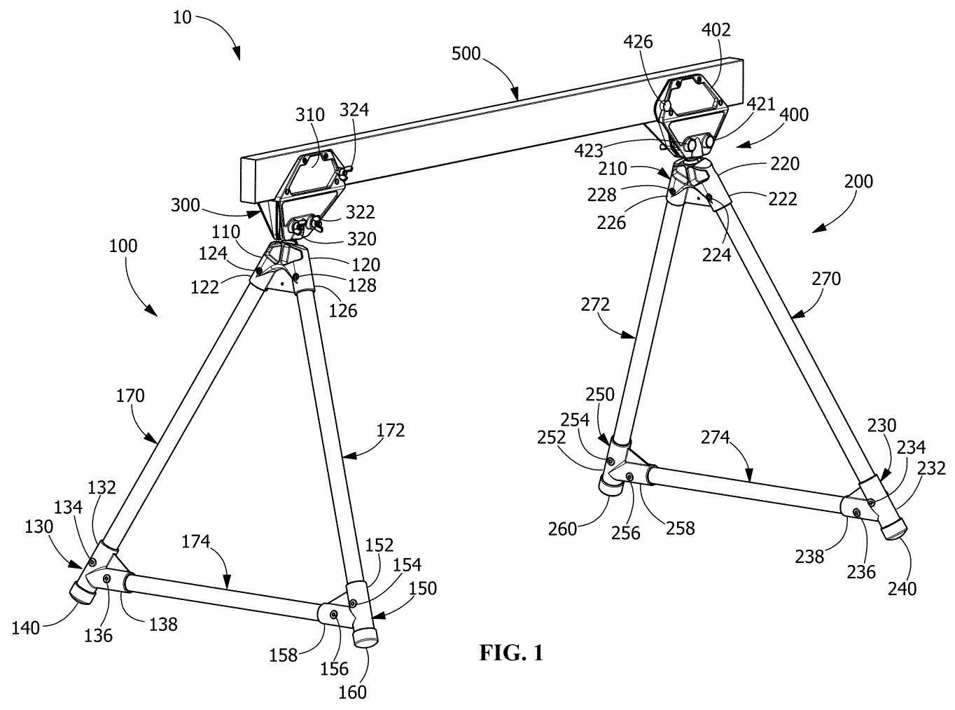

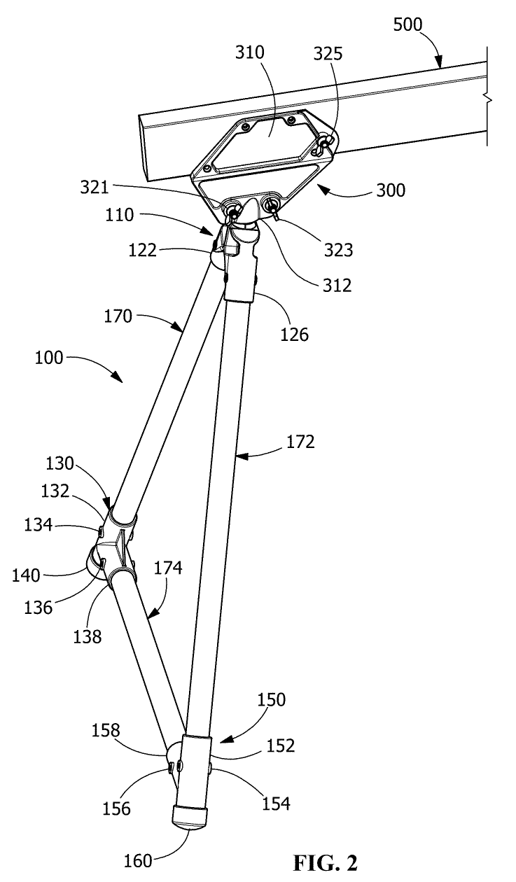

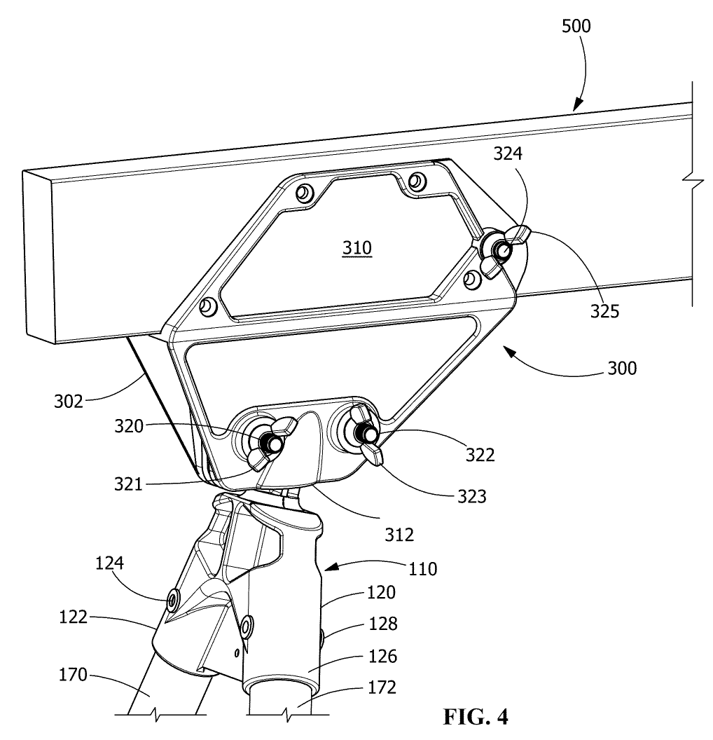

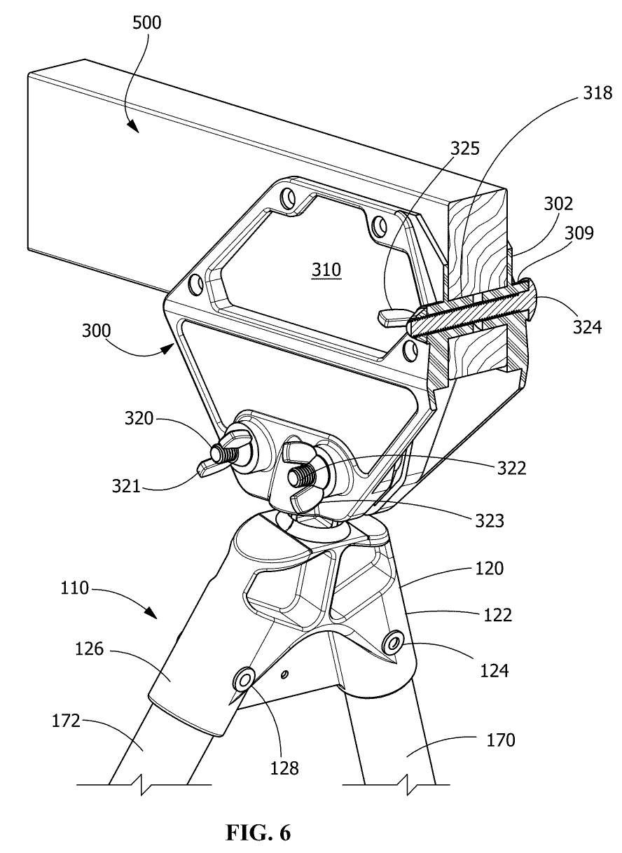

With reference to FIGS. 1-7, first leg assembly 100 includes first pivot device 110, which further includes flange 112 and stem 114; and upper leg receptacle 120, which further includes first leg-receiving portion 122, first bolt or rivet 124 for securing the upper portion of first leg 170 within first leg-receiving portion 122, second leg-receiving portion 126, and second bolt or rivet 128, for securing the upper portion of second leg 172 within second leg-receiving portion 126. First corner leg receptacle 130 includes leg-receiving portion 132 for receiving the bottom portion of first leg 170 therein, and crossbar-receiving portion 138 for receiving one side of crossbar 174 therein. First rivet 134 secures the bottom portion of first leg 170 in first corner leg receptacle 130 and second rivet 136 secures crossbar 174 in first corner leg receptacle 130. Cap 140 covers the bottom edge of first corner leg receptacle 130. Second corner leg receptacle 150 includes leg-receiving portion 152 for securely receiving the bottom portion of second leg 172 therein, and crossbar-receiving portion 158 for receiving the other side of crossbar 174 securely therein. First rivet 154 secures the bottom portion of first leg 170 in second corner leg receptacle 150 and second rivet 156 secures crossbar 174 in second corner leg receptacle 150. Cap 160 covers the bottom edge of second corner leg receptacle 150.

Again, with reference to FIGS. 1-7, second leg assembly 200 includes second pivot device 210, which further includes flange 212 and stem 214; and upper leg receptacle 220, which further includes first leg-receiving portion 222, first bolt or rivet 224 for securing the upper portion of first leg 270 within first leg-receiving portion 222, second leg-receiving portion 226, and second bolt or rivet 228, for securing the upper portion of second leg 272 within second leg-receiving portion 226. First corner leg receptacle 230 includes leg-receiving portion 232 for receiving the bottom portion of first leg 270 therein, and crossbar-receiving portion 238 for receiving one side of crossbar 274 therein. First rivet 234 secures the bottom portion of first leg 270 in first corner leg receptacle 230 and second rivet 236 secures crossbar 274 in first corner leg receptacle 230. Cap 240 covers the bottom edge of first corner leg receptacle 230. Second corner leg receptacle 250 includes leg-receiving portion 252 for securely receiving the bottom portion of second leg 272 therein, and crossbar-receiving portion 258 for receiving the other side of crossbar 274 securely therein. First rivet 254 secures the bottom portion of leg 270 in second corner leg receptacle 250 and second rivet 256 secures crossbar 274 in second corner leg receptacle 250. Cap 260 covers the bottom edge of second corner leg receptacle 250.

Most self-leveling platforms using the present invention will include two or more collapsible leg assemblies 200 attached to the bottom of the platform by a bracket assembly that permits the platform to be leveled on uneven surfaces in the manner described above. An exemplary embodiment of first rotating bracket assembly 300, which is used with first leg assembly 100, and second rotating bracket assembly 400, which is used with second leg assembly 200 is shown in the Figures.

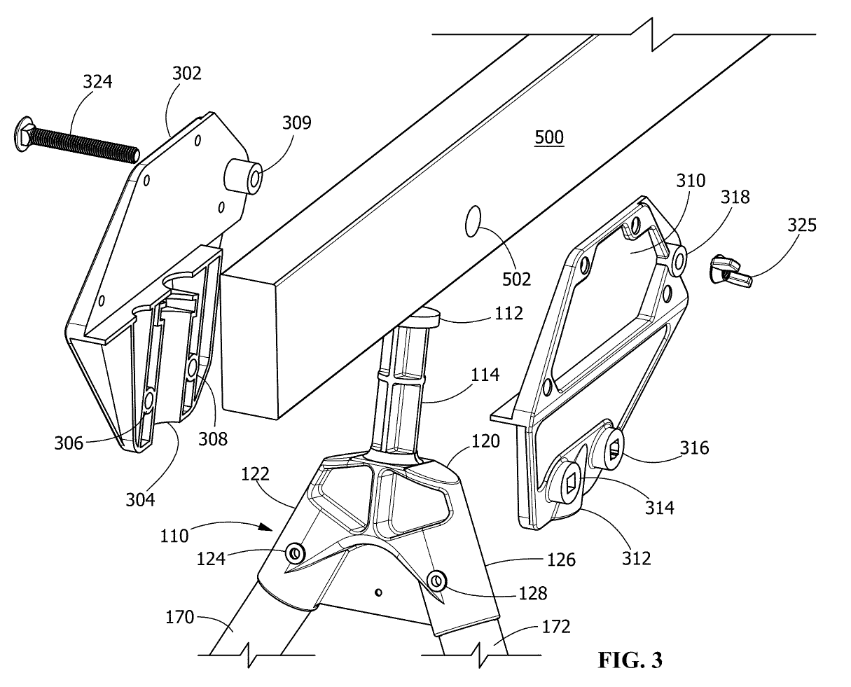

As best shown in FIG. 3, first rotating bracket assembly 300 includes first bracket portion 302, which further includes flange and stem receiving portion 304, bolt receiving apertures 306 and 308, and carriage bolt receiving structure 309; and second bracket portion 310, which further includes flange and stem receiving region or portion 312, bolt receiving apertures 314 and 316, and carriage bolt receiving structure 318. In a manner similar to what is disclosed in U.S. Pat. Nos. 9,140,401 and 9,453,608, when fully assembled, first and second bracket portions 302 and 310 cooperate with one another to enclose and house flange 112 and stem 114 in a manner that permits pivot device 110 to freely pivot and rotate within bracket assembly 300. In a manner basically identical to what in shown in FIG. 3, but in a reversed orientation, second rotating bracket assembly 400 includes first bracket portion 402, which further includes flange and stem receiving portion 404, bolt receiving apertures 306 and 308, and carriage bolt receiving structure 409; and second bracket portion 410, which further includes flange and stem receiving region or portion 412, bolt receiving apertures 414 and 416, and carriage bolt receiving structure 418. In a manner similar to what is disclosed in U.S. Pat. Nos. 9,140,401 and 9,453,608, when fully assembled, first and second bracket portions 402 and 410 cooperate with one another to enclose and house flange 212 and stem 214 in a manner that permits pivot device 210 to freely pivot and rotate within bracket assembly 300.

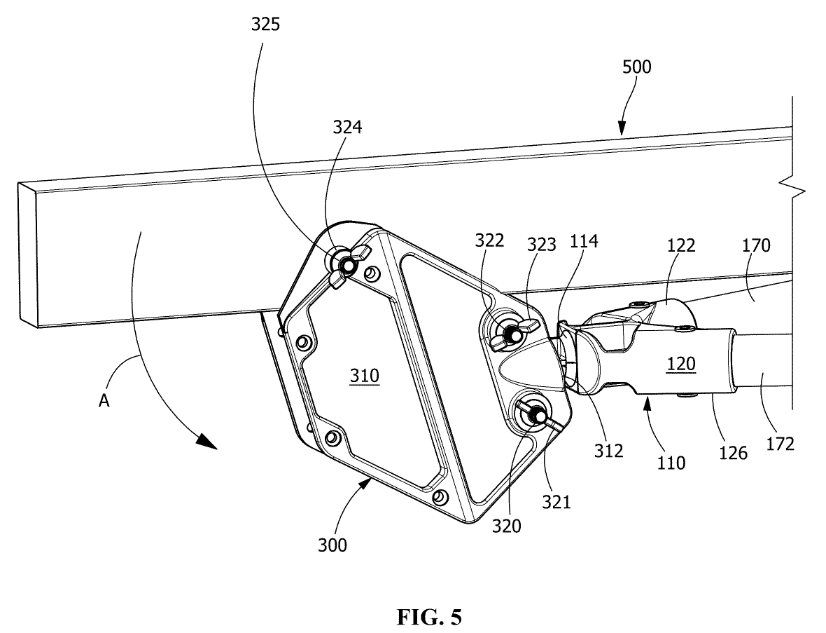

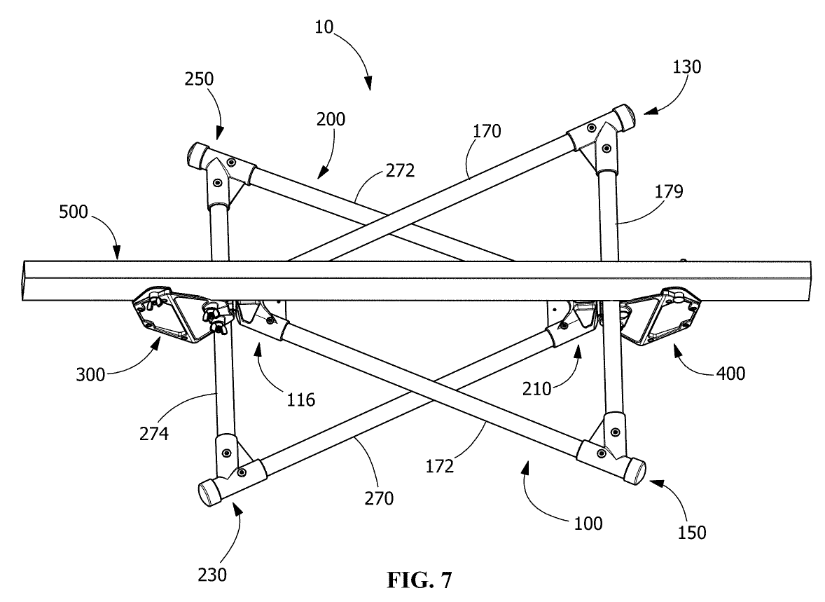

As best shown in FIG. 3, to assemble and mount first rotating bracket assembly 300 on support member 500, carriage bolt receiving structure 309 (e.g., a collar or sleeve) of first bracket portion 302 is inserted into aperture 502 (see FIG. 3) and carriage bolt 324 is inserted therethrough into carriage bolt receiving structure 318 on second bracket portion 310. Carriage bolt receiving structure 309 rotates or pivots within aperture 502, thereby permitting the entire bracket assembly to rotate downward as shown in FIGS. 5 and 7 (see directional arrow A in FIG. 5). Third wing nut 325 is then tightened down on carriage bolt 324. First bolt 320 is inserted through both bolt receiving apertures 306 and 314 and first wing nut 321 is then tightened down on first bolt 320. Second bolt 322 is inserted through both bolt receiving apertures 308 and 316 and second wing nut 323 is then tightened down on second bolt 322. With reference to FIG. 1 and FIG. 3, to assemble and mount second rotating bracket assembly 400 on support member 500, carriage bolt receiving structure 409 (e.g., a collar or sleeve) of first bracket portion 402 is inserted into aperture 504 (not shown) and carriage bolt 424 is inserted therethrough into carriage bolt receiving structure 418 on second bracket portion 410. Third wing nut 425 is then tightened down on carriage bolt 424. Carriage bolt receiving structure 409 rotates or pivots within aperture 504, thereby permitting the entire bracket assembly to rotate downward as shown in FIGS. 5 and 7 (see directional arrow A in FIG. 5, although it is to be understood that second bracket assembly 400 rotates in the opposite direction). First bolt 420 is inserted through both bolt receiving apertures 406 and 414 and first wing nut 421 is then tightened down on first bolt 420. Second bolt 422 is inserted through both bolt receiving apertures 408 and 416 and second wing nut 423 is then tightened down on second bolt 422. As will be appreciated by one of ordinary skill in the art, other attachment means or joining members, such as pins, rods, dowels, rivets, or the like, may be used to connect the two halves of the rotating bracket assemblies to one another. In some embodiments, the two halves of the rotating bracket assemblies are permanently attached to one another by adhesive means or other attachments means such as welding.

When leg assemblies 100 and 200 of self-leveling device 10 are in their fully extended positions as shown in FIG. 1, a user of the device may rotate the leg assemblies into a partially or completely closed position by simply exerting force inwardly on the leg assemblies until they come to rest in the position shown in FIG. 7. Collapsing the leg assemblies in this manner may be facilitated by loosening wing nuts 325 and 425. Leg assemblies 100 and 200 may also be configured in the manner disclosed in U.S. patent application Ser. No. 15/878,730, which is incorporated by reference herein in its entirety for all purposes. While the embodiment of bracket assembly 300/400 shown in FIGS. 1-7 is designed to be rotatably mounted on a crossbeam (e.g., a 2×4 piece of lumber), the mechanical relationship between bracket assembly 300/400 and pivot devices 110/210 is consistent across all current STABLZ® products. Accordingly, the self-leveling feature in each embodiment functions in basically the same or very similar manner. Upper leg receptacle 120/220, first lower leg receptacle 130/230, second lower leg receptacle 150/250, first leg 170/270, second leg 172/272, crossbar 174/274, and bracket assembly 300/400 are typically manufactured from any suitable plastic, polymer, metal, or combinations thereof. Other leg assemblies are compatible with vertical support bracket 300, such as the leg assemblies disclosed in U.S. patent application Ser. No. 15/878,730, which is incorporated by reference herein, in its entirety for all purposes.

While the present invention has been illustrated by the description of exemplary embodiments thereof, and while the embodiments have been described in certain detail, there is no intention to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the general inventive concept.

What is claimed:

1. A rotatable bracket assembly for use with self-leveling devices, comprising:
(a) a first bracket portion, wherein the first bracket portion further includes:
(i) an upper region having an outer surface and a substantially flat inner surface, wherein a cylindrical carriage bolt receiving structure is formed on one end of the inner surface; and
(ii) a lower region having an outer surface and an inner surface, wherein a stem and flange receiving region is formed on the inner surface; and
(b) a second bracket portion, wherein the second bracket portion is adapted to be connected to the to the first bracket portion, and wherein the second bracket portion further includes:
(i) an upper region having an outer surface and a substantially flat inner surface, wherein a cylindrical carriage bolt receiving structure is formed on one end of the inner surface; and
(ii) a lower region having an outer surface and an inner surface, wherein a stem and flange receiving region is formed on the inner surface.

2. The rotatable bracket assembly of claim 1, wherein the lower regions of the first and second bracket portions further include at least one aperture adapted to receive a joining member therethrough for attaching the first and second bracket portions to one another.

3. The rotatable bracket assembly of claim 1, wherein the first bracket portion and second bracket portion are permanently connected to one another.

4. The rotatable bracket assembly of claim 1, wherein the first bracket portion and second bracket portion are detachably connected to one another.

5. The rotatable bracket assembly of claim 1, wherein the first bracket portion and second bracket portion are hexagonal in shape.

6. A rotatable bracket assembly for use with self-leveling devices, comprising:
(a) a first bracket portion, wherein the first bracket portion further includes:
(i) an upper region having an outer surface and a substantially flat inner surface, wherein a cylindrical carriage bolt receiving structure is formed on one end of the inner surface; and
(ii) a lower region having an outer surface and an inner surface, wherein a stem and flange receiving region is formed on the inner surface; and
(b) a second bracket portion, wherein the second bracket portion is adapted to be connected to the first bracket portion, and wherein the second bracket portion further includes:
(i) an upper region having an outer surface and a substantially flat inner surface, wherein a cylindrical carriage bolt receiving structure is formed on one end of the inner surface; and
(ii) a lower region having an outer surface and an inner surface, wherein a stem and flange receiving region is formed on the inner surface, wherein
(c) the stem and flange receiving region in the first bracket portion and the stem and flange receiving region in the second bracket portion cooperate with one another to receive and enclose a rotating and pivoting leg assembly, and wherein the rotating and pivoting leg assembly includes a pivot device, and wherein the pivot device further includes an elongated stem, and a flange formed atop the elongated stem.

7. The rotatable bracket assembly of claim 6, wherein the lower regions of the first and second bracket portions further include at least one aperture adapted to receive a joining member therethrough for attaching the first and second bracket portions to one another.

8. The rotatable bracket assembly of claim 6, wherein the first bracket portion and second bracket portion are permanently connected to one another.

9. The rotatable bracket assembly of claim 6, wherein the first bracket portion and second bracket portion are detachably connected to one another.

10. The rotatable bracket assembly of claim 6, wherein the first bracket portion and second bracket portion are hexagonal in shape.

11. The rotatable bracket assembly of claim 6, wherein the pivot device further includes a leg receiving portion positioned beneath the stem, and wherein the leg receiving portion is adapted to receive at least two legs therein.

12. The rotatable bracket assembly of claim 6, wherein the rotating and pivoting leg assembly further is triangular in shape and further includes two legs and a cross bar positioned between the two legs.

13. A rotatable bracket assembly for use with self-leveling devices, comprising:
(a) a horizontally-oriented crossbar, wherein the crossbar further includes at least one aperture formed therein and passing completely therethrough;
(b) a first bracket portion adapted to be rotatably mounted on the crossbar, wherein the first bracket portion further includes:
(i) an upper region having an outer surface and a substantially flat inner surface, wherein a cylindrical carriage bolt receiving structure is formed on one end of the inner surface, and wherein the cylindrical carriage bolt receiving structure is adapted to be disposed within the at least one aperture formed in the crossbar; and
(ii) a lower region having an outer surface and an inner surface, wherein a stem and flange receiving region is formed on the inner surface; and
(b) a second bracket portion adapted to be rotatably mounted on the crossbar, wherein the second bracket portion is adapted to be connected to the first bracket portion, and wherein the second bracket portion further includes:
(i) an upper region having an outer surface and a substantially flat inner surface, wherein a cylindrical carriage bolt receiving structure is formed on one end of the inner surface, and wherein the cylindrical carriage bolt receiving structure is adapted to be disposed within the at least one aperture formed in the crossbar; and
(ii) a lower region having an outer surface and an inner surface, wherein a stem and flange receiving region is formed on the inner surface, wherein
(c) the stem and flange receiving region in the first bracket portion and the stem and flange receiving region in the second bracket portion cooperate with one another to receive and enclose a rotating and pivoting leg assembly, and wherein the rotating and pivoting leg assembly includes a pivot device, and wherein the pivot device further includes an elongated stem, and a flange formed atop the elongated stem.

14. The rotatable bracket assembly of claim 13, wherein the lower regions of the first and second bracket portions further include at least one aperture adapted to receive a joining member therethrough for attaching the first and second bracket portions to one another.

15. The rotatable bracket assembly of claim 13, wherein the first bracket portion and second bracket portion are permanently connected to one another.

16. The rotatable bracket assembly of claim 13, wherein the first bracket portion and second bracket portion are detachably connected to one another.

17. The rotatable bracket assembly of claim 13, wherein the first bracket portion and second bracket portion are hexagonal in shape.

18. The rotatable bracket assembly of claim 13, wherein the pivot device further includes a leg receiving portion positioned beneath the stem, and wherein the leg receiving portion is adapted to receive at least two legs therein.

19. The rotatable bracket assembly of claim 13, wherein the rotating and pivoting leg assembly further is triangular in shape and further includes two legs and a cross bar positioned between the two legs.

20. The rotatable bracket assembly of claim 13, wherein the bracket assembly is manufactured from polymer, plastic, metal, or a combination thereof.
